(19) United States
(12) Patent Application Publication
(10) Pub. No.: US 2009/0194021 A1
(43) Pub. Date: Aug. 6, 2009

(54) DISPENSER FOR A COATING APPARATUS HAVING REDUCED SAG

(76) Inventors: Scott Snodgrass, (US); Gregory M. Gibson, (US)

Correspondence Address: STORM LLP, BANK OF AMERICA PLAZA, 901 MAIN STREET, SUITE 7100, DALLAS, TX, 75202, US

(21) Appl. No.: 12/024,547

(22) Filed: Feb. 1, 2008

(51) Int. Cl. B05C 5/00

(52) U.S. Cl. 118/323

(57) ABSTRACT

To date, it has been difficult to extrude precision films onto large substrates efficiently, thus, limiting the size of the substrate. One reason for the difficulty is natural sag or deflection in an extrusion head applying the film to the substrate. To counteract this deflection or sag, a crossbar has been designed that provides a substantially rigid platform to mount an extrusion head, which counteracts the deflection or sag, thus allowing for efficient extrusion of precision films over exceedingly large substrates.

### TECHNICAL FIELD

The invention relates generally to apparatus for the extrusion of viscous liquid onto horizontal surfaces and, more particularly, such apparatus for the application of thin film coatings to glass and similar substrate materials.

### BACKGROUND

The use of extrusion coating apparatus in the application of liquid films to glass and similar substrates is becoming increasingly common as thin-film displays (TFDs), including Liquid Crystal Displays (LCDs) and Thin Film Transistors (TFTs), rise in commercial popularity as video screens and television monitors. Such extrusion coating apparatus typically employs an extrusion head or die that is moved relative to the substrate to coat the substrate with the film material in a uniform and precisely controlled fashion.

In the production of such TFDs, as well as semiconductors and other devices that use precision film applications, there has been a limitation on the overall size of the substrates because vertical deflection or sag in the extrusion head or die introduces variation and thus affects the ability to provide a generally uniform coating over a large substrate. Generally, this sag or deflection occurs because the extrusion head or die is supported on a beam that must be of relatively long length to span a large substrate. The beam cannot be supported along its length because to do so would inhibit the ability of the beam to move relative to the substrate.

To date, there has not been an adequate system for precisely and controllably suspending an extrusion die or head over a substrate to provide a generally uniform coating of an extrudate. Some examples of suspension arrangements are found U.S. Pat. Nos. 3,703,880; 5,693,143; 6,942,753; and 7,169,229, and U.S. Patent Application Publication No. 3005/0103267. However, none of these applications adequately addresses the need for reduced sag or deflection in a suspension arrangement for precision extrusion applications.

### SUMMARY

A preferred embodiment of the present invention, accordingly, provides an apparatus for coating a substrate. The apparatus comprises a chuck that secures the substrate in a generally horizontal position, a shuttle secured to the crossbar adapted for relative movement between the substrate and the extrusion die, a reservoir containing a supply of the extrudate, a pump in fluid communication with the reservoir and the extrusion die that is adapted to apply work to the extrudate to move the extrudate from the reservoir to the extrusion die, a crossbar, and an extrusion die having a first and an opposite second end, the extrusion die having a length between the first and the second ends, where the extrusion die has a first predetermined deflection along at least a portion of its length and is adapted to extrude onto the substrate an extrudate at least along a portion of its length. The crossbar further includes a second predetermined deflection along at least a portion of its length, a base member having a length, a width, a first side, and an opposite second side that is secured to the extrusion die along at least a portion of its length and suspends the extrusion die above the substrate, a vertical member that extends generally perpendicular from the second side of the base member forming a T-shape, and a generally rectangular cap having a length and having a width that is less than the width of the base member, the cap extending from the vertical member that can be dimensioned to provide sufficient rigidity to the base member and vertical member in a generally horizontal direction to counteract the first predetermined deflection such that a combined predetermined deflection of the crossbar and extrusion die when secured to one another is less than the first and second predetermined deflection.

In another preferred embodiment of the present invention the length of the cap is about the same length as the base member.

In another preferred embodiment of the present invention, the crossbar further comprises a pair of flanges that extend generally perpendicular from the base member and perpendicular from the vertical member.

In another preferred embodiment of the present invention, the vertical member further comprises a plurality of passages that extend therethrough.

Another preferred embodiment of the present invention also provides an apparatus for coating a substrate. The apparatus comprises a chuck that secures the substrate in a generally horizontal position, a crossbar, a shuttle secured to the crossbar adapted for relative movement between the substrate and the extrusion die, a reservoir containing a supply of the extrudate, a pump in fluid communication with the reservoir and the extrusion die that is adapted to apply work to the extrudate to move the extrudate from the reservoir to the extrusion die, and an extrusion die having a first and an opposite second end and having a length between the first and the second ends. The extrusion die has a first predetermined deflection along at least a portion of its length and is adapted to extrude onto the substrate an extrudate along an extrusion length measuring greater than about 400 mm. The crossbar includes a second predetermined deflection along at least a portion of its length, a base member having a length, a width, a first side, and an opposite second side that is secured to the extrusion die along at least a portion of its length and suspending the extrusion die above the substrate, a vertical member that extends generally perpendicular from the second side of the base member forming a T-shape, and a generally rectangular cap having a length and having a width that is less than the width of the base member that extends from the vertical member. Additionally, the base, the vertical member, the cap, and the extrusion die together can be dimensioned to have moment of inertia to have a combined deflection of less than the first and second predetermined deflections.

In another preferred embodiment of the present invention, the combined deflection is less than about 10 microns.

Another preferred embodiment of the present invention, a crossbar that is secured to a shuttle in extrusion apparatus for supporting an extrusion die having a first predetermined deflection is provided. The crossbar has a second predetermined deflection along at least a portion of its length. A base member is included having a length, a width, a first side, and an opposite second side, the base member being secured to the extrusion die along at least a portion of its length and suspending the extrusion die above the substrate. A vertical member is included that extends generally perpendicular from the second side of the base member forming a T-shape. Also, a generally rectangular cap is included having a length and having a width that is less than the width of the base member. The cap extends from the vertical member and is dimensioned to provide sufficient rigidity to the base member and vertical member in a generally horizontal direction to counteract the first predetermined deflection such that a combined predetermined deflection of the crossbar and extrusion die when secured to one another is less than the first and second predetermined deflections.

In accordance with a preferred embodiment of the present invention, the length of the cap is about the same length as the base member.

In accordance with a preferred embodiment of the present invention, the crossbar further comprises a pair of flanges that extend generally perpendicular from the base member and perpendicular from the vertical member.

In accordance with a preferred embodiment of the present invention, the vertical member further comprises a plurality of passages that extend therethrough.

A preferred embodiment of the present invention, accordingly, provides an apparatus for coating a substrate. A chuck secures the substrate in a generally horizontal position in the apparatus. An extrusion die having a first and an opposite second end with a length between the first and the second ends and a first predetermined deflection along at least a portion of its length is adapted to extrude onto the substrate an extrudate along an extrusion length measuring greater than about 400 mm. Supporting the extrusion die is a crossbar having a second predetermined length along at least a portion of its length, a base, a vertical member, and a cap. The base member has a length, a width, a first side, and an opposite second side, and the base member is secured to the extrusion die along at least a portion of its length, suspending the extrusion die above the substrate. The vertical member extends generally perpendicular from the second side of the base member forming a T-shape. A generally rectangular cap having a length and having a width that is less than the width of the base member extends from the vertical member. The base, the vertical member, and the cap together are dimensioned to have moment of inertia to have a combined deflection of crossbar and extrusion die that is less than the first and second predetermined deflections. A shuttle is secured to the crossbar adapted for relative movement between the substrate and the extrusion die, and a reservoir containing a supply of the extrudate is provided. A pump is in fluid communication with the reservoir and the extrusion die, where the pump is adapted to apply work to the extrudate to move the extrudate from the reservoir to the extrusion die.

In accordance with a preferred embodiment of the present invention, the combined deflection is less than about 10 microns.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of an apparatus for coating in accordance with a preferred embodiment of the present invention;

FIG. 2 is an exemplary block diagram of the pumping system in accordance with a preferred embodiment of the present invention;

FIG. 3 is an exploded isometric view of the crossbar and extrusion die in accordance with a preferred embodiment of the present invention;

FIG. 4 is a front elevation view of the crossbar and extrusion die of FIG. 3;

FIG. 5 is a cross-sectional view of the crossbar and extrusion die along the section line A-A of FIG. 4; and

FIG. 6 is a breakout view of the cap and vertical member of the crossbar taken along the section line B-B of FIG. 5.

### DETAILED DESCRIPTION

Refer now to the drawings wherein depicted elements are, for the sake of clarity, not necessarily shown to scale and wherein like or similar elements are designated by the same reference numeral through the several views.

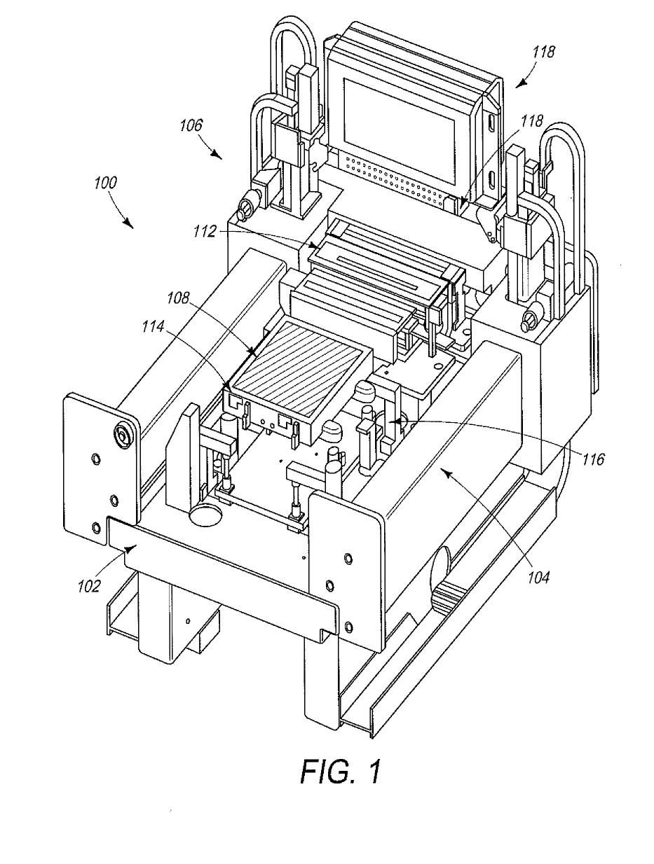

Referring to FIG. 1 of the drawings, the reference numeral 100 generally depicts the coating apparatus 100 according to a preferred embodiment of the present invention. Coating apparatus 100 includes a base 102 with a rail system 104 mounted thereon. Base 102 forms a foundation along which the shuttle or transport system 106 travels for cleaning and priming of the extrusion head or die 118 (typically occurring at a utility station 112 at the periphery of base 102), and for conducting the coating operations of the substrate 108 (typically by traversing the die 118 over the substrate in a selected pattern). Preferably, the extrusion head or die 118 and a gauging member (not shown) are mounted to a bridge 110, which extends generally transversely between the rails of the rail system 104. The extrusion head 118 is preferably a linear extrusion head attached to fluid manifold preferably containing a bead forming orifice substantially as described in U.S. Pat. No. 4,696,885, titled “METHOD OF FORMING A LARGE SURFACE AREA INTEGRATED CIRCUIT.”

Also, a chuck 114 is secured to the base 102 through chuck holders 116. Chuck 114 provides support to and securely and precisely positions substrate 108 relative to base 102 and the remainder of the coating apparatus. Preferably, the chuck 114 employs a vacuum to secure or “hold down” the substrate 108 in a generally fixed horizontal position relative to the shuttle 106 during operation of the coating apparatus 100. In a preferred embodiment of this invention, chuck holder 116 comprises a structure which will preferably support the chuck 114 principally at a plurality of points around the periphery of the chuck 114. Correspondingly, the chuck 114 is formed (typically ground) so that it is as flat as possible as supported. Alternatively, the chuck 114 can be formed so as to selectively deform to compensate for deformation in the shuttle 106 and head 118.

In particular, a gauging member (not shown) can be implemented on the shuttle 106 to monitor and assist in “fine tuning” the gap between the dispenser or extrusion head 118 and the substrate 108 in real time during the coating operation. A height sensor as part of the gauging member (not shown) is appropriately zeroed while the head 118 is at the correct height relative to the substrate, and a correction signal is subsequently generated whenever the height deviates above or below the preset level. The height sensor typically comprises one or more non-contact laser sensors that measure the relative height above the substrate 108, which constitutes an indirect feedback control. Alternatively, a physically contacting probe or rod can be used to supply direct feedback control.

These feedback controls are used by a control system to adjust the height (“gap”) of the extrusion head 118 relative to the bridge 110. The control system for the gauging member generally comprises computer hardware and software that convert the feedback signal into information suitable to drive the position motor(s) to move and restore the extrusion head 118 to the proper height. This process of height self-correction typically begins at the start of the coating process and continues throughout the coating process. However, it is preferable to make this adjustment only at the start of the coating process (to compensate for various thicknesses of different substrates), and to not make adjustments during the coating.

In operation, the extrusion head 118 moves above the substrate 108, which is supported by chuck 114. During motion of the extrusion head 118, its height can be adjusted by the gauging member and its associated control system (not shown). The travel of the shuttle 106 preferably will be at least long enough to permit the extrusion head 118 to traverse and coat the largest substrate to be placed on the apparatus 100 and to clear or traverse beyond the substrate 108 by a sufficient distance to permit the substrate 108 to be removed by external personnel or machinery. This range of travel may be reduced by providing for some movement of the substrate 108 during coating, but at some cost to precision and accuracy. The travel of the shuttle 106 preferably is long enough so that in addition to clearing the substrate 108, the shuttle 106 will be able to gain access to utility station 112.

To reduce the system footprint and to improve coating performance, particularly on the leading edge of a substrate 108 (starting point for the coating operation), substrate 108 is located as close as possible to utility station 112. Preferably, shuttle 106 carries the bridge 110 and the extrusion head 118 to the utility station 112 for head cleaning and for priming of the bead either before or during the loading of the substrate 108. The shuttle 106 then carries the bridge 110 and the extrusion head 118 to the near edge of the substrate 108 (the side closest to the station 112) so that coating of the substrate 108 may begin. Extrusion is accomplished by moving an extrudate (such as color filter resist and photoresist) with a pump (not shown) from a reservoir (not shown) to the extrusion die 118. The shuttle 106 then carries the extrusion head 118 across the substrate at a carefully monitored and predetermined rate, preferably under computer control, while the extrusion head 118 dispenses coating material at a controlled rate onto the substrate 108. Once the shuttle 106 has traveled to a point where the extrusion head 118 has coated the entire substrate 108 or that portion to be coated, extrudate flow to the extrusion head 118 is discontinued.

It should also be appreciated that there is no limitation that the present invention coat the entire surface of the substrate 108. For example, the motion of the head 118 may be stopped at some point prior to fully coating a substrate 108 where only a portion of the substrate 108 is desired to be coated.

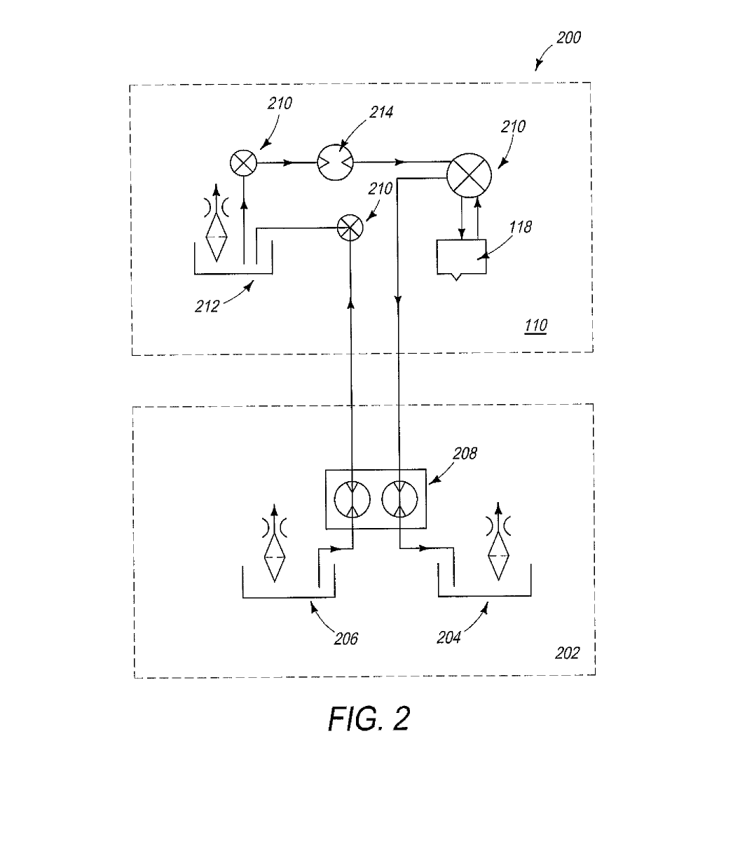

In order to extrude the extrudate through the die 118, pumping system 200 depicted in FIG. 2 is employed. Preferably, pumping system 200 employs components mounted on bridge 110 (namely, extrusion head 118, valves 210, an optional intermediate reservoir 212, and pump 214) and a pumping station 202 (which is located in the utility station 112). Pumping station 202 comprises a source reservoir 204, a drain reservoir 206, and pumps 208. Pumps 208 perform mechanical work on the extrudate in the pumping system 200 to move the source extrudate from the source reservoir 204 to the bridge 110 and to move excess or drain extrudate from bridge 110 to the drain reservoir 206. When extrudate is moved from the source reservoir 204, the extrudate is optionally moved to an intermediate reservoir for temporary storage. From the intermediate reservoir 212, pump 214 performs mechanical work on the extrudate to move the extrudate from the intermediate reservoir 212 to the extrusion die 118. Excess or drain extrudate can then be moved directly from the extrusion head 118 to the pumping station 202. Additionally, along the entire system 200, a number of values 210 can be used to control the flow of extrudate.

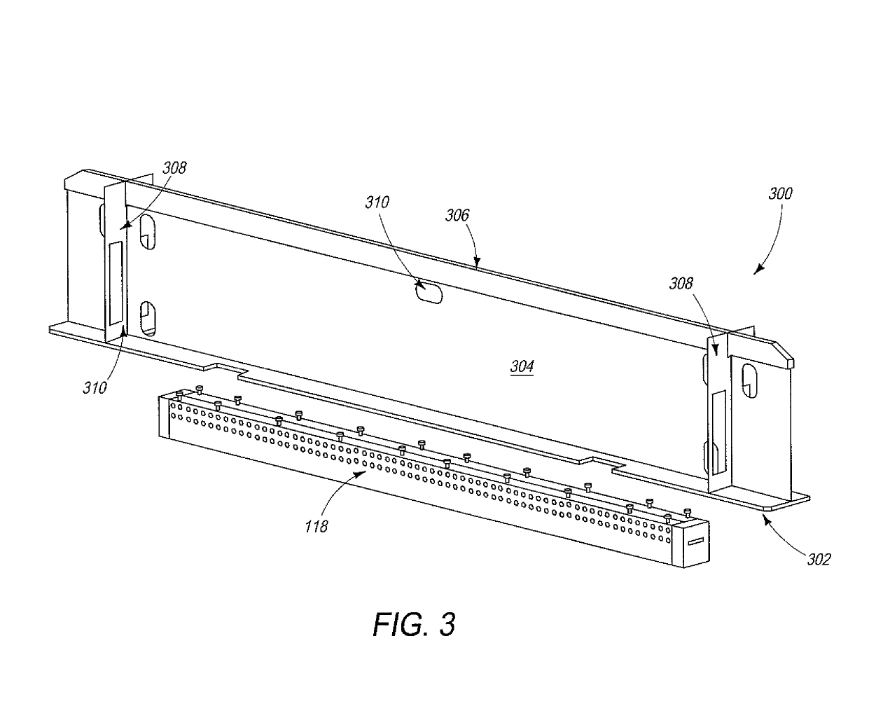

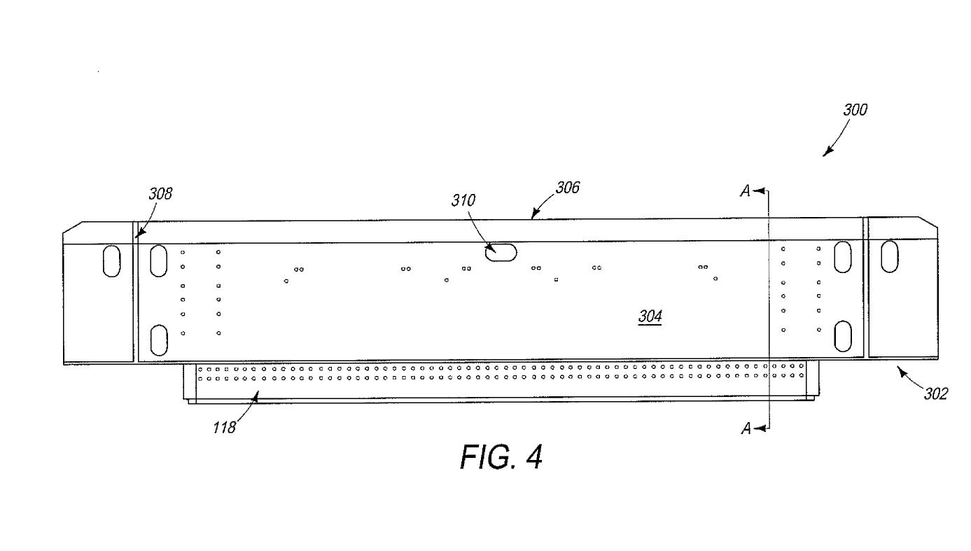

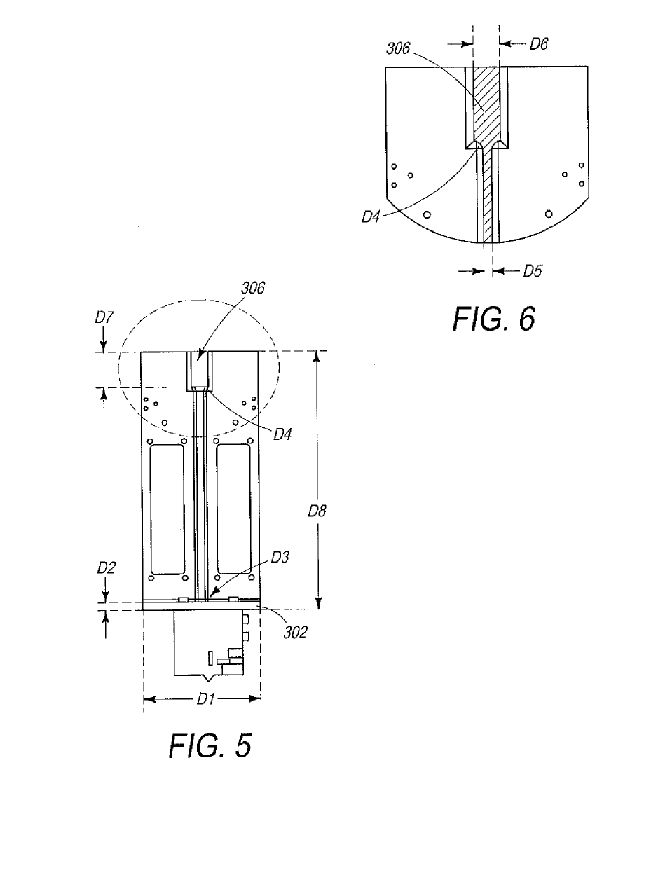

Included with the bridge 110, which cannot readily be seen in FIG. 1, is a crossbar 300. Crossbar 300 and extrusion head 118 can be seen in greater detail in FIGS. 3 through 6. Preferably, the crossbar 300 is secured to the shuttle 106 and suspended in a position that is generally parallel to the substrate. The crossbar 300 provides structural support for the extrusion head 118 as it pass over the substrates. This particular crossbar typically is used for substrates having a width greater than 400 mm.

In particular, the crossbar 300 according to a preferred embodiment of the present invention is designed to reduce the sag or deflection in the extrusion head 118. Generally, the extrusion head 118 has been (and still is) suspended from either end. Because of gravitational effects and because the dispensing head 118 is not an infinitely rigid material, the dispensing head 118 sags or has vertical deflection. This deflection typically reaches a maximum at the center of the suspension, which can be as much as 100 microns depending on the overall length of the dispensing head. Such a deviation can adversely affect the ability to provide a generally uniform coat (typically less than 1 micron difference in height across the entire substrate). To accomplish this, the crossbar 300 is comprised of several components: a base or base member 302, a vertical member 304, a cap 306, and flanges 310. For example, these pieces can all be formed from or machined from a block of either AISI 304 stainless steel or AA 606′-T6 aluminum.

The two most apparent and easily viewable components are the base 302 and the vertical member 304. The base 302 is a generally rectangular member and is typically suspended over (generally parallel to) the substrate 108, with its flat surface parallel to the substrate. As can be seen in FIGS. 3 through 6, the extrusion head or die 118 is bolted to the base member 302. Extending perpendicular from approximately the center of the base 302 (opposite the extrusion head 118) is the vertical member 304. These two members 302 and 304 together form an inverted T-shaped beam.

The combination of the base 302 and vertical member 304, though, generally do not provide sufficient rigidity without being overly large or heavy. As the base 302 and vertical member 304 are suspended over the substrate 108, the bottom of the base 302 (side facing the extrusion head 118) and the extrusion head 118 are in tension while the upper end of the vertical member 304 is in compression. Thus, to provide additional rigidity to the base 302 and vertical member 304, a generally rectangular cap 306 extends from the upper end of the vertical member 304. This cap 304 provides rigidity in the horizontal direction, directly counteracting the compression occurring in the upper end of the vertical member 304. This additional rigidity in the horizontal direction, in turn, counteracts the natural sag or deflection in the extrusion head 118, allowing for there to be a relatively small and acceptable deflection across the length of the extrusion head 118.

The cap 306 is narrower in its minor dimension than base 302. In the case where the base 302 and the cap 306 have roughly equivalent lengths and widths, the crossbar 300 takes the form of an I-beam. For applications such as extrusion for LCDs, semiconductors, and other thin film applications, the conventional I-beam cross section has excess weight in the upper region that can reintroduce sag or deflection, despite the increased rigidity of the shape. Thus, one feature of a preferred embodiment of the present invention is to maintain a width “w” of the cap 306 that is less than the width “W” of the base 302. Additionally, under some circumstances, the cap 306 can have a length “l” that is less than the length “L” of either the base 302 and/or vertical member 304. Generally, the cross-section of the combined base 302, vertical member 304 and cap 306 is selected or dimensioned to have a maximum deflection of less than about 10 microns along the extrusion length and is specifically adjusted for each given length and for each cross-section of the extrusion head (such as extrusion head 118) for which the base 302 is secured.

An exemplary application of a crossbar 300 according to a preferred embodiment of the present invention in conjunction with an extrusion head 118 having an extrusion length (the length over which the extrusion head 118 is able to apply a film of an extrudate) of greater than about 400 mm (or about 16 inches) is as follows. Assuming a crossbar made of AISI 304 stainless steel having a density of about 0.254 lbs/in³, a length of about 95 inches, and a weight of about 691.3 lbs (which includes the extrusion head 118), the moment of inertia (which includes the extrusion head 118) is chosen to be 1049 in⁴ by varying the heights and widths of the base 302, vertical member 304, and cap 306. Preferably, for this example, the width of the base member 302 (D1), the height of the base member 302 (D2), the radii of curvature of the joints between the vertical member 304 and base member 302 (D3), the radii of curvature of the joints between the vertical member 304 and the cap 306 (D4), the width of the vertical member 304 (D5), the width of the cap 306 (D6), the height of the cap (D7) and the overall height (D8) are chosen to be about 7 inches, about 0.480 inches, about 0.250 inches, about 0.250 inches, about 1 inch, about 2.5 inches, and about 18 inches, respectively. Individually, the deflection of the crossbar 300 (by itself and under its own weight) is about 12.4 microns, while the deflection of the extrusion head 118 is about 100 microns. However, when combined the overall deflection is markedly diminished to about 6.44372 microns (in a “worst case scenario”). The overall maximum deflection of the crossbar 300 and extrusion head 118 would be typically be about 60% of the “worst case” deflection or about 3.86623 microns.

In addition to the base 302, vertical member 304, and cap 306, several other features are provided on the crossbar 300. As can be seen in FIGS. 3 through 6, there are a pair of flanges 308 near each end of crossbar 300. These flanges 308, too, are generally rectangular and extend perpendicular from the base 302 and vertical member 304. Additionally, through the flanges 308 and the vertical member 302, there are also a number of portals 310. These portals 310 allow wiring, pneumatic lines, and hydraulic lines to be passed through.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. An apparatus for coating a substrate, comprising:
a chuck that secures the substrate in a generally horizontal position;
an extrusion die having a first and an opposite second end, the extrusion die having a length between the first and the second ends, and the extrusion die having a first predetermined deflection along at least a portion of its length, and the extrusion die being adapted to extrude onto the substrate an extrudate at least along a portion of its length;
a crossbar having:
a second predetermined deflection along at least a portion of its length;
a base member having a length, a width, a first side, and an opposite second side, the base member being secured to the extrusion die along at least a portion of its length and suspending the extrusion die above the substrate;
a vertical member that extends generally perpendicular from the second side of the base member forming a T-shape; and
a generally rectangular cap having a length and having a width that is less than the width of the base member, the cap extending from the vertical member, and the cap being dimensioned to provide sufficient rigidity to the base member and vertical member in a generally horizontal direction to counteract the first predetermined deflection such that a combined predetermined deflection of the crossbar and extrusion die when secured to one another is less than the first and second predetermined deflection;
a shuttle secured to the crossbar adapted for relative movement between the substrate and the extrusion die;
a reservoir containing a supply of the extrudate; and
a pump in fluid communication with the reservoir and the extrusion die, the pump being adapted to apply work to the extrudate to move the extrudate from the reservoir to the extrusion die.

2. The apparatus of claim 1, wherein the length of the cap is about the same length as the base member.

3. The apparatus of claim 1, wherein the crossbar further comprises a pair of flanges that extend generally perpendicular from the base member and perpendicular from the vertical member.

4. The apparatus of claim 1, wherein the vertical member further comprises a plurality of passages that extend therethrough.

5. An apparatus for coating a substrate, comprising:
a chuck that secures the substrate in a generally horizontal position;
an extrusion die having a first and an opposite second end, the extrusion die having a length between the first and the second ends, and the extrusion die having a first predetermined deflection along at least a portion of its length, and the extrusion die being adapted to extrude onto the substrate an extrudate along an extrusion length measuring greater than about 400 mm;
a crossbar having:
a second predetermined deflection along at least a portion of its length;
a base member having a length, a width, a first side, and an opposite second side, the base member being secured to the extrusion die along at least a portion of its length and suspending the extrusion die above the substrate;
a vertical member that extends generally perpendicular from the second side of the base member forming a T-shape;
a generally rectangular cap having a length and having a width that is less than the width of the base member, and the cap extending from the vertical member;
the base, the vertical member, the cap, and the extrusion die together being dimensioned to have moment of inertia to have a combined deflection of less than the first and second predetermined deflections;
a shuttle secured to the crossbar adapted for relative movement between the substrate and the extrusion die;
a reservoir containing a supply of the extrudate; and
a pump in fluid communication with the reservoir and the extrusion die, the pump being adapted to apply work to the extrudate to move the extrudate from the reservoir to the extrusion die.

6. The apparatus claim 5, wherein the combined deflection is less than about 10 microns.

7. The apparatus of claim 5, wherein the length of the cap is about the same length as the base member.

8. The apparatus of claim 5, wherein the crossbar further comprises a pair of flanges that extend generally perpendicular from the base member and perpendicular from the vertical member.

9. The apparatus of claim 5, wherein the vertical member further comprises a plurality of passages that extend therethrough.

10. A crossbar that is secured to a shuttle in extrusion apparatus for supporting an extrusion die having a first predetermined deflection, the crossbar having a second predetermined deflection along at least a portion of its length, and the crossbar comprising:
a base member having a length, a width, a first side, and an opposite second side, the base member being secured to the extrusion die along at least a portion of its length and suspending the extrusion die above the substrate;
a vertical member that extends generally perpendicular from the second side of the base member forming a T-shape; and
a generally rectangular cap having a length and having a width that is less than the width of the base member, the cap extending from the vertical member, and the cap being dimensioned to provide sufficient rigidity to the base member and vertical member in a generally horizontal direction to counteract the first predetermined deflection such that a combined predetermined deflection of the crossbar and extrusion die when secured to one another is less than the first and second predetermined deflections.

10. The apparatus of claim 9, wherein the length of the cap is about the same length as the base member.

11. The apparatus of claim 9, wherein the crossbar further comprises a pair of flanges that extend generally perpendicular from the base member and perpendicular from the vertical member.

12. The apparatus of claim 9, wherein the vertical member further comprises a plurality of passages that extend therethrough.
